(19) United States
(12) Patent Application Publication
(10) Pub. No.: US 2023/0233978 A1
(43) Pub. Date: Jul. 27, 2023

(54) WOUND-PLEATED FILTERS AND RELATED METHODS

(71) Applicant: ENTEGRIS, INC., Billerica, MA (US)

(72) Inventors: John P. Puglia, Townsend, MA (US); Marc Laverdiere, Wakefield, MA (US); Andrew Richardson Bates, Billerica, MA (US)

(21) Appl. No.: 18/097,657

(22) Filed: Jan. 17, 2023

Related U.S. Application Data
(60) Provisional application No. 63/301,929, filed on Jan. 21, 2022.

(51) Int. Cl. B01D 46/52; B01D 69/12; B01D 71/66

(52) U.S. Cl. CPC B01D 46/521; B01D 69/1251; B01D 71/66; B01D 2325/022; B01D 2325/028; B01D 2325/02831

(57) ABSTRACT

Described are wound-pleated filters and methods of preparing and using these filters.

### FIELD

The following description relates to wound-pleated filters and methods of preparing and using these filters.

### BACKGROUND

Filters are used in industry to remove unwanted materials from fluids. Examples of fluids that are processed using filters include air, drinking water, liquid industrial solvents and processing fluids, industrial gases used for manufacturing or processing (e.g., in semiconductor fabrication), and liquids that have medical or pharmaceutical uses.

Different types of filters are designed for processing different fluids. Some filters remove significant amounts of large (in a relative sense) materials from a flow of gas or liquid, e.g., dust particles from air, or bacteria or cellular material from a biological fluid. Other filters are used to remove barely-detectable amounts of sub-microscopic, non-solid materials such as chemical molecules (e.g., hydrocarbons or metal atoms or ions) suspended or dissolved in a gas or a liquid. Impurities and contaminants that are removed from these types of fluids include micron-scale or nano-scale dissolved or suspended molecules contained in a fluid in an amount in a range of parts per million or less. An example of this type of filtering application is to purify a liquid solvent solution that is useful in microelectronic and semiconductor processing.

Common filter designs contain a porous filter element that allows a flow of fluid to pass freely through the element, but that also retains impurities or particles that are contained in the fluid to remove those impurities or particles from the fluid. In this context, “removing” an impurity or particle from a flow of fluid refers to a process that reduces a total amount of an impurity or particle that is present in the flow of fluid, but that does not necessarily remove an entire amount of the impurity or particle from the flow of fluid.

Filter materials (sometimes referred to as “filter elements”) that are used for different fluid applications may be chosen from a variety of useful materials, such as: porous polymeric membranes (films); thin, fibrous, woven and non-woven sheets made of organic or synthetic fibers, open-pore foam sheets, adsorbent materials (particles), liquids, among others.

Fluid passes through the filter material, and unwanted materials in the fluid (referred to as “impurities”) are retained in the filter material. By one filtering mechanism, referred to as a “sieving” mechanism, as liquid passes through the filter material the liquid and any impurity that is smaller than pores of the filter material will pass through the filter element, while impurities that have a size that is larger than the pores will be retained by the filter and separated from the fluid. By a different filtration mechanism, referred to as a “non-sieving” mechanism, an impurity is not removed by physical separation (sieving), but is attracted to the surface of the filter material by an electrostatic or chemical interaction. An impurity such as a dissolved (in a liquid) or suspended (in a gas) chemical molecule (e.g., a hydrocarbon, metal, or metal ion) can be chemically or electrostatically attracted to a material of the filter medium, and can be retained by the filter material.

A filter product may be a “dead end” type of filter, or a “by-pass” or “recirculating” type of filter. A dead end filter includes a filter element contained in a housing; a fluid that enters the housing must pass through the filter element to flow out of the housing as a filtrate. A by-pass filter design also includes a filter element contained in a housing, but as a difference, fluid that flows into the housing may either pass through the membrane then exit the housing as a filtrate, or pass through the housing without passing through the membrane as a by-pass flow (“concentrate” or “retentate”). The filter housing includes an inlet, an outlet for a filtrate, and an outlet for a by-pass fluid stream. The by-pass flow may be re-circulated through the same filter housing and filter element, or may be passed through a separate filter element in a separate filter housing.

Standard filters for processing many fluids are of a “pleated cylinder filter” design. A pleated cylinder filter-type product includes a cylinder-shaped housing that is adapted to contain a pleated filter element in a flow path between an inlet of the housing and an outlet of the housing. The filter is typically a dead-end style filter that requires fluid that enters the housing at the inlet to pass through the pleated filter element before exiting the housing at the outlet. The pleated filter element has a cylindrical configuration with folded pleats formed by length-wise folds that extend along the length and central axis of the cylindrical filter element. The cylindrical pleated filter element can include a cylindrical outer support (e.g., a “cage”), a cylindrical inner support (“core”), and an open interior space or channel along the center and central axis of the cylinder, i.e., an open cylindrical interior space. When flowing through the cartridge, the liquid flows through the interior channel either before or after passing through the filter element.

When designing filters for industrial use, particularly for use in a clean room for semiconductor or microelectronic device manufacturing, filter design may emphasize a high amount of filter element area per volume of the filter. Pleated cylinder filter designs, which have for decades been the standard filter type for these filtering applications, have been developed and refined to a degree that allows little additional room for improvement. Filter membranes have been made progressively thinner, and the ability to increase membrane area per filter volume by reducing membrane thickness has approached or reached a limit. The ability to increase membrane area per filter volume by removing support layers or reducing the thickness of support layers has also approached or reached a limit.

### SUMMARY

The present description relates to novel and inventive wound-pleated filters, methods of making the wound-pleated filters, and methods of using the wound-pleated filters, for example to remove a trace impurity from a process fluid.

Wound-pleated filter products are not commonly used in industry, and to the Applicant's understanding have gone un-used in applications of removing trace impurities having particle sizes below 100 nanometers from liquids and gases.

The Applicant has identified certain types of novel and inventive wound-pleated filter designs that are effective for use in filtering highly pure liquid and gaseous fluids that contain trace amounts of impurities, in particular for processing liquids and gases used in processing highly pure semiconductor and microelectronic devices (sometimes referred to as “process fluid”).

A wound-pleated filter includes a cylindrical filter structure made with a multi-layer filter membrane assembly that includes two or more filter membrane layers, and that is wound along a length of the assembly about a central longitudinal axis. Each filter membrane layer of the assembly has first and second ends that extend along the length of the membrane layer. As part of the wound assembly, the length-wise ends of the membrane layers are part of a first wound pleat located at a first filter end of the wound-pleated filter, and a second wound pleat that is located at a second filter end of the wound-pleated filter. The wound-pleated filter can be contained in a filter housing that includes a housing inlet and a housing outlet in a configuration that requires fluid that flows into the housing inlet to flow through a filter membrane layer before exiting the housing by passing through the housing outlet.

In the form of the wound-pleated filter, the multi-layer filter membrane assembly forms multiple windings, with one “winding” referring to a portion of the total length of the assembly that wraps one revolution around the central axis. Each layer of the wound-pleated filter is alternately connected to each of two adjacent layers as part of an inlet pleat at the inlet end of one adjacent layer and as part of an outlet pleat at the outlet end of the second adjacent layer. Two “adjacent” layers may be part of one winding of the multi-layer filter assembly, or, a membrane layer that is adjacent to another membrane layer may be part of a different winding that is at the inside of the winding (closer to the center of the winding) or at the outside of the winding (farther from the center of the winding). Membrane layer ends that form pleats in an “alternating” manner are filter membrane layers of the wound-pleated filter that have a first end (e.g., “inlet” or “front” end) that forms a pleat with a first end (e.g., “inlet” or “front” end) of a first adjacent filter membrane layer, and a second end (e.g., “outlet” or “back” end) that forms a pleat with a second end (“outlet” or “back” end) of a second, i.e., different, adjacent filter membrane layer.

Preferred wound-pleated filters can include a high amount of filter membrane area per volume of the filter. A wound-pleated filter as described can have multiple times the filter membrane area per filter volume of standard pleated cylinder filter designs, e.g., two times, four times, or five or more times the area of filter membrane per volume compared to commercial pleated cylinder filter designs (with filter membrane and spacer layers having identical thicknesses).

As an additional advantage, a useful or preferred wound-pleated filter as described may contain a significantly-reduced amount of supportive layers in a filter product structure, meaning a reduced amount of non-filtering layers, i.e., layers that do not function to remove an impurity. Typically, a standard pleated cylinder filter design may include two support layers per filter membrane layer: one non-filtering support layer is located on an inlet side of the filter membrane layer, and one non-filtering support layer is located on an outlet side of the filter membrane layer. A wound-pleated filter design as described can include and may require fewer supportive layers per filter layer, e.g., one support layer (spacer layer) per one filter membrane layer. That is, one support layer can serve as the support for two separate membrane layers on the upstream side, or one support layer can serve as the support for two separate membrane layers on the downstream side. In a conventional cylindrical pleated filter, due to the nature of the assembly process, at least two layers of support become located between adjacent membrane layers on an inlet or an outlet side. According to example wound-pleated filter designs as described herein, only one layer of support is present between adjacent membrane layers on an inlet or an outlet side of the filter.

Example wound-pleated filters can be useful for applications that remove small amounts of impurities (e.g., “trace impurities”) from a liquid that is already highly pure. “Removing” an impurity from a fluid means to remove at least a portion of an impurity from the fluid, i.e., to reduce the amount of the impurity that is present in the fluid, while possibly not removing all of the impurity from the fluid.

An impurity, also referred to as a “contaminant,” may be a chemical material that is present in a fluid (e.g., a process fluid) at a very low amount, e.g., at a concentration in a parts-per-million or parts-per-billion range, or lower. Example process fluids that may be filtered or purified using a rolled-pleated filter as described include process fluids that have already been processed and purified to remove an amount of impurities, but that still contain a very low amount of remaining impurities, which are present in only “trace” amounts. The terms “parts-per-million” and “parts-per billion” are used in a manner that is consistent with the use of these terms in the chemical arts, including in the arts of manufacturing microelectronic and semiconductor devices. In this respect, parts per million (PPM) is commonly used as a dimensionless measure of small levels (concentrations) of a contaminant in fluid (a gas or liquid), expressed as milligrams contaminant per liter fluid (mg/L), and measures the mass of the contaminant per volume of the fluid. One part per million is equal to 0.000001 units.

An impurity in a process fluid is a chemical material that is different from the process fluid, that is dissolved in a liquid process fluid or suspended in a gaseous process fluid. Examples, described chemically, include hydrocarbon molecules that may be uncharged or charged (ionic) molecules and oligomers, and inorganic compounds such as metal oxides (titanium dioxide), metal atoms, metal ions, etc.

On a basis of size, a trace impurity in a process fluid can have a size (a largest dimension) of less than 100 nanometers, less than 90, 50, 25, 10, 5, or 1 nanometer. Particles of these sizes, if present in a process fluid used for processing a semiconductor or microelectronic device, can produce a defect on the device and reduce a process yield.

A trace impurity can be present initially in a process fluid in an amount of less than 100, 10, or 1 part-per-million, or less than 100, 10, or 1 part-per-billion. By passing the process fluid through a wound-pleated filter as described, the concentration of the trace impurity may be reduced by at least 20, 50, 70, or 80 percent, i.e., the filter will remove at least 20, 50, 70, or 80 percent of the trace impurity from the process fluid.

When being used to remove these types of trace impurities from a process fluid, a rolled-pleated filter as described can have an extended useful lifetime, measured in volume fluid passing through the filter, of thousands of liters, e.g., 1,000, 5,000, or 10,000 liters. When removing a trace impurity from a fluid over a useful lifetime in this range, the amount of trace impurity that accumulates within the filter may take up less than 2 percent or less than 1 percent of the total available surface area of a filter membrane.

Compared to conventional pleated cylinder filter designs, a rolled-pleated filter can have relative advantages that allow for a more efficient filter to be produced, having a larger amount of filter membrane present per volume of the filter. A rolled-pleated filter of the present description can be prepared with just one spacer layer being required per filter membrane layer while the standard pleated cylinder filter design inherently includes two spacer layers per filter membrane layer. The described rolled-pleated design also allows for the elimination of an open channel of the type that is needed to be present at a central axis and core of a pleated cylinder design. In place of the open channel at a core, a rolled-pleated filter product can include an additional amount of rolled filter membrane. A rolled-pleated filter also: has no limit on pleat height; does not experience a large pressurized outer diameter surface; does not require fluid to pass through the central opening of the cylinder; has highly uniform packing density; and experiences reduced pleat damage at the pleated edges of the filter membrane layers, due to assembly method and flow patterns.

In one aspect, the following description relates to a wound-pleated filter useful to reduce an amount of a trace impurity in a fluid. The wound-pleated filter includes: a multi-layer filter membrane assembly comprising a first porous filter membrane layer and a second porous filter membrane layer, each of the first porous filter membrane layer and the second porous filter membrane layer comprising an inlet surface, an outlet surface, a length, an inlet end that extends along the length, an outlet end that extends along the length, and a width between the inlet end and the outlet end. The porous filter membrane layer assembly is wound along the length, about a central axis, to form the wound-pleated filter. The inlet surface of the first porous filter membrane layer faces an inlet surface of the second porous filter membrane layer. The filter also includes: a wound inlet pleat that includes inlet ends of adjacent filter membrane layers at an inlet end of the wound-pleated filter, and a wound outlet pleat that includes outlet ends of adjacent filter membrane layers at an outlet end of the wound-pleated filter.

In another aspect, the description relates to a wound-pleated filter. The filter includes a multi-layer filter membrane assembly that includes a first porous filter membrane layer and a second porous filter membrane layer, each of the first porous filter membrane layer and the second porous filter membrane layer including an inlet surface, an outlet surface, a length, an inlet end that extends along the length, an outlet end that extends along the length, and a width between the inlet end and the outlet end. The porous filter membrane layer assembly is wound along the length and about a central axis to form the wound-pleated filter, which includes multiple porous filter membrane layer assembly windings. The inlet surface of the first porous filter membrane layer faces an inlet surface of the second porous filter membrane layer. The filter also includes: a pleat comprising an outlet end of the first porous filter membrane layer and an outlet end of an adjacent porous filter membrane layer, the pleat comprising a fold, a weld, or a thermoplastic bonding agent; wound inlet ends of the membrane layers at an inlet end of the wound-pleated filter; and wound outlet ends of the membrane layers at an outlet end of the wound-pleated filter.

In another aspect, the description relates to methods of removing an impurity from a fluid by causing the fluid to pass through a filter of the present description, the fluid comprising a trace impurity, such that the filter membrane retains a portion of the trace impurity.

In another aspect, the description relates to a method of preparing a wound-pleated filter. The method includes: with a multi-layer filter membrane assembly that includes a first porous filter membrane layer and a second porous filter membrane layer, each of the first porous filter membrane layer and the second porous filter membrane layer having an inlet surface, an outlet surface, a length, an inlet end that extends along the length, an outlet end that extends along the length, and a width between the inlet end and the outlet end; and with the inlet surface of the first porous filter membrane layer facing an inlet surface of the second porous filter membrane layer; winding the multi-layer filter membrane assembly to form the wound-pleated filter comprising multiple porous filter membrane layer assembly windings, forming a pleat comprising an outlet end of the first porous filter membrane layer and an outlet end of an adjacent porous filter membrane layer, the pleat comprising a fold, a weld, or a thermoplastic bonding agent, and forming a pleat comprising an inlet end of the first porous filter membrane layer and an inlet end of an adjacent porous filter membrane layer, the pleat comprising a fold, a weld, or a thermoplastic bonding agent.

In yet another aspect, the description relates to a method of preparing a rolled-pleated filter, from multiple membrane layers. The method includes: aligning the front and back edges of the membrane layers; rolling the layers along lengths of the layers to form a wound-rolled filter having multiple windings; and connecting the adjacent front and back edges of alternating membrane layers of the windings.

### BRIEF DESCRIPTION OF THE DRAWINGS

FIG. 1 is a cut-away view of an example rolled-pleated filter as described, in a filter housing.

FIGS. 2A and 2B show side-perspective views of example multi-layer filter membrane assemblies as described.

FIG. 3 is an end view of an example rolled-pleated filter as described.

FIG. 4A is an end-perspective view of an example rolled-pleated filter as described.

FIG. 4B is an example cut-away view of a portion of an example FIG. 3 rolled-pleated filter as described.

FIGS. 5A through 5F show steps of an example method of preparing a rolled-pleated filter as described.

FIGS. 6A, 6B, 6C and 6D show examples of automated steps of methods for preparing a rolled-pleated filter.

FIG. 7 shows the alignment of layers in a rolled pleated filter.

FIGS. 8A, 8B, and 8C show example filter products as described, including a rolled-pleated filter and a housing.

All figures are schematic and not to scale.

### DETAILED DESCRIPTION

The present invention provides a wound-pleated filter, sometimes referred to herein as a “rolled-pleated” filter, that includes a cylindrical filter structure that includes a multi-layer filter membrane assembly that is wound (or “rolled”) along a length of the assembly about a central longitudinal axis of the wound-pleated filter. The multi-layer filter assembly includes multiple (at least two) filter membrane layers. In the form of the wound-pleated filter, length-wise first and second (front and back, or inlet and outlet) ends of the filter layers are formed into first and second wound pleats that are located at opposite ends of the rolled-pleated filter structure. Alternating ends of the filter membrane layers are formed (e.g., folded or connected) into pleats, and the membrane assembly is wound into a wound-pleated filter that includes a wound inlet pleat and a wound outlet pleat, with inlet sides (inlet surfaces) of the filter membrane layers, connected by the pleats, on one side of the filter membrane layers, and outlet sides (outlet surfaces) of the filter membrane layers, connected by the pleats, on the second (opposite) side of the filter membrane layers.

A multi-layer filter membrane assembly includes (comprises) at least two filter membrane layers. Each of the two filter membrane layers has a length, a width, a thickness, a front end (alternately referred to as a “first” end or an “inlet” end) along the length, and a back end (alternately referred to as a “second” end or an outlet end) also along the length. Each membrane layer also has two opposed surfaces separated by the thickness of the membrane layer, one surface being referred to herein as a front surface (alternately referred to as a “first” surface or an “inlet” surface) and one surface being referred to as a back surface (alternately referred to as a “second” surface or a “back” surface).

When the filter layers are part of the multi-layer filter membrane assembly, the width and the front end and the back end of the two membranes are all substantially aligned, along the length. The two (or more) membrane layers of an assembly are also flat along their widths and face each other with a first (front) surface of a membrane layer facing a first (front) surface of an adjacent membrane layer.

A surface that “faces” an adjacent surface means that two surfaces are generally opposed and located in parallel or substantially in parallel. The two surfaces may be in direct opposed contact or may face each other through an intermediate layer such as a spacer layer that is present between two surfaces of adjacent filter membranes.

Accordingly, in addition to at least two filter membrane layers, one or more additional filtering or non-filtering layers may be present in an assembly, such as a spacer layer or one or more additional filter membrane layers. A spacer layer may be present between a first membrane layer and an adjacent membrane layer (between the front surface of a first membrane layer and a front surface of an adjacent (second) membrane layer). Alternately or additionally, a second spacer layer may be located at a back surface (outlet surface) of a membrane layer so that when the layer is wound, the second spacer layer becomes located between the back surface of a first membrane layer and a back surface of an adjacent (second) membrane layer.

As desired, the wound-pleated filter may be designed for use to process a flow of fluid in only one direction (for “single-direction” use), or may be designed to be used to process a flow of fluid in either of two directions between an inlet and an outlet, i.e., in a selected direction through the filter at a start of use that does not change during use.

In the form of the wound-pleated filter, the multi-layer filter layer assembly may form multiple windings, with one “winding” referring to a portion of the total length of the multi-layer assembly that wraps once (one revolution) around the central axis. The wound-pleated filter, containing multiple windings, is formed of the two or more filter membrane layers of the wound multi-layer assembly that become located adjacent to each other. Generally, i.e., other than an inner-most membrane layer and an outermost membrane layer, each filter membrane layer forms a pleat at each of its two ends with an end of each of its two adjacent filter membrane layers, with one end of the filter membrane layer forming a pleat with an end of one adjacent filter membrane layer and the second end of the filter membrane layer forming a pleat with an end of a different adjacent filter membrane layer.

Each filter layer has an inlet surface that faces (opposes) an inlet surface of an adjacent layer and also an outlet surface that faces an outlet surface of a different adjacent layer (with the exception of an inner-most filter membrane layer and an outer-most filter membrane layer). Two adjacent layers may be part of one winding of the multi-layer filter assembly, or an adjacent layer of a layer may be part of a different winding to the inside of the layer (closer to the center of the winding) or to the outside of the layer (farther from the center of the winding). An inner-most layer of a first inner winding will not have an adjacent layer to the inside, and an outer-most layer of a final outer winding will not have an adjacent layer to the outside.

In example wound-pleated filters, a filter membrane layer that has a front surface that faces a front surface of an adjacent membrane layer can form a pleat with that adjacent membrane layer at a second (back) end of the two layers; the filter membrane layer has a back surface that faces a back surface of a second (different) adjacent membrane layer, and can form a pleat with the second (different) adjacent membrane layer at a first (front) end. In this arrangement, each filter membrane layer of a wound-pleated filter has a front surface that faces a front surface of a first adjacent filter membrane layer, a back surface that faces a back surface of a second adjacent filter membrane layer, a front end that forms a pleat with a front end of the second adjacent filter membrane layer, and a back end that forms a pleat with a back end of the first adjacent filter membrane layer.

The first (front) surface of each filter membrane layer is open to a first (front, inlet) filter end of the wound-rolled filter and to an inlet space that is adjacent to and between two opposed front (inlet) surfaces of a pair of adjacent filter membrane layers that are connected and form a pleat at the back end of each of the two adjacent filter membrane layers. The inlet space and the first surface of each of the adjacent membranes are open to, i.e., in fluid communication with, the first (front, inlet) filter end of the rolled-pleated filter, optionally with a spacer positioned at the inlet space between the two opposed front surfaces of the pair of adjacent filter membrane layers. The inlet space has a volume that may contain a spacer layer between the two opposed first (front) surfaces, or may have a volume of just the space between the two opposed first (front) surfaces with no spacer between the two front surfaces.

The second (back) surface of each filter membrane layer is open to a second (back, outlet) filter end of the wound-rolled filter and to an outlet space that is adjacent to and between two opposed back surfaces of a pair of adjacent filter membrane layers that are connected and form a pleat at a first (front, inlet) end of each of the two adjacent filter membrane layers. The outlet space and the second (back, outlet) surface of each of the two adjacent filter membrane layers are in fluid communication with the second filter end of the wound rolled filter, optionally through a spacer. The outlet space has a volume that may contain a spacer layer between the two opposed second (back) surfaces, or may have a volume of just the space between the two opposed second (back) surfaces with no spacer between the two back surfaces.

In use, a fluid (liquid or gas) is introduced to a first filter end of the rolled-pleated filter, which is exposed to the inlet space and inlet surfaces of the membranes. The fluid can flow into the inlet space and contact a front (inlet) side of a filter membrane layer. The fluid can flow through the filter membrane layer and traverse the thickness of the layer and the second (outlet) surface of the filter membrane layer to flow into the outlet space and the second (outlet) filter end of the rolled-pleated filter. The rolled-pleated filter can be constructed as a dead-end filter, with a filter housing that requires that all fluid passing into a housing inlet must pass through a filter membrane layer of the rolled-pleated filter before the fluid leaves the filter housing through a housing outlet.

A rolled-pleated filter as described is different from typical “pleated cylinder filter” designs that are in common commercial use. A “pleated cylinder filter” refers to a filter that includes a cylindrical, pleated filter element that includes multiple length-wise (not wound) parallel pleats that extend along the filter element in a direction of a central axis of the pleated cylinder filter, and that also includes an open central channel in a direction along the central axis of the pleated cylinder filter. While a pleated cylinder filter may be used as a “dead-end”-type filter, the pleats of this design are not located at wound ends of the pleated cylinder filter, but extend in alignment with a central axis of the cylinder. In use, fluid flows through the central channel (“central opening”) of the pleated cylinder filter either before or after the fluid passes through the pleated filter element.

In contrast, with the Applicant's presently-described wound-pleated filter design, fluid does not need to flow or be present within a central opening of the filter. A central opening is not necessary and the space along the central axis of the rolled-pleated filter may be used for other purposes, such as to contain additional length of wound filter membrane layers, or to contain one or more devices that improve or monitor the performance of the rolled-pleated filter.

As non-limiting examples, a rolled-pleated filter may include any of the following in a space along a central axis of the filter: a sensor to monitor filter life of a rolled-pleated filter during use; a monitor to sense trapped gas in a filter housing; a venting mechanism to remove trapped gas; a draining mechanism to remove trapped fluids such as for servicing; an optical particle counter to measure particles in a sample of fluid passing through the filter; a sensor to measure capacitance, pressure, or temperature of a fluid; or a sensor to measure any other condition or parameter that would be useful to measure during use of the filter.

A wound-pleated filter as described is also different from typical “spiral-wound filter” designs that are in common commercial use for specific applications. A “spiral-wound filter” refers to common commercial filter products that include spirally-wound filter membranes that do not involve alternating pleated (folded, bonded, welded, or otherwise connected) wound ends at the opposed filter ends of a wound cylinder, and that also involve the presence and flow of fluid within a central channel (opening) of the filter. Examples of these types of a spiral-wound filter products are commonly used in reverse-osmosis filtration systems that involve a by-pass or re-circulating mode of operation. Typical systems that include these types of spiral-wound filter membranes involve multiple flowpaths within a filter housing, including a flowpath through a filter membrane (for a “permeate”) within the housing, as well as an alternative flowpath (for a non-filtered “concentrate” or “retentate”) that by-passes the filter membrane. Fluid that enters a housing that contains this type of spiral-wound filter may exit the filter housing without passing through the filter membrane.

A rolled-pleated filter can be made of any multi-layer membrane assembly that includes any useful number of membrane layers (e.g., 2, 4, 6, etc.), that has any useful length or width, and that is assembled to include any useful number of windings. Example filters can be prepared from a multi-layer membrane assembly that has a length of from 1 to 100 meters, e.g., from 2 to 20 or 50 meters. An example rolled-pleated filter may include from 1 to 500 windings, e.g., from 2 to 300 windings. A rolled-pleated filter may be wound about a central axis with essentially no open space along the central axis, or with a space that has any useful or relatively small diameter, such as an opening having a diameter in a range from 0.125 to 1 inch. The membrane assembly and layers of the membrane assembly may have a width (which becomes a “length” of a wound filter) in a range from 10 to 100 centimeters, e.g., from 20 to 50 centimeters. Example membranes may have a total surface area at an inlet surface in a range from 0.1 or 0.5 to 100 square meters, e.g., from 10 to 80 square meters, and can be selected by the number of windings.

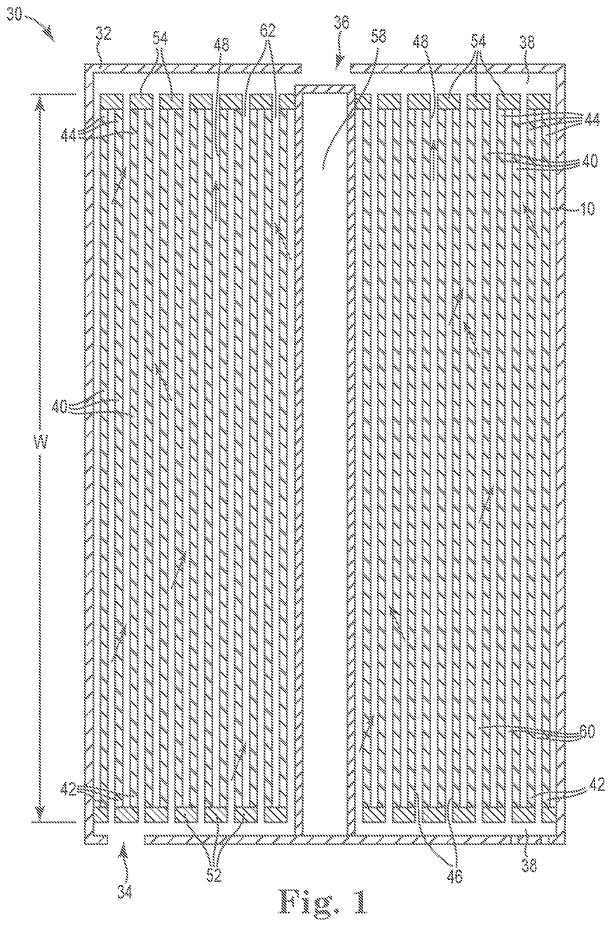

An example of a rolled-pleated filter as described, in a filter housing, is shown at FIG. 1. As illustrated, filter assembly 30 includes filter (e.g., filter cartridge) 10 and housing 32. Housing 32 includes inlet 34 at one end (a bottom end) of housing 32, and outlet 36 at a second end (a top end) of housing 32. Housing 32 defines interior space 38, which is adapted to contain filter 10 in a manner that requires fluid that enters housing inlet 34 to pass through a filter membrane layer of filter 10 before the fluid passes through housing outlet 36; i.e., filter assembly 30 is configured as a “dead-end” type of filter assembly. Filter 30 may optionally include additional inlets and outlets (e.g., vents) that are commonly present as part of a dead end-type filter and used intermittently to vent or drain a housing.

Filter 10 is a rolled-pleated filter as described herein. Filter 10 includes multiple wound filter membrane layers 40, with alternating pleated (folded, bonded, or otherwise connected) edges. Filter membrane layers 40 are wound around a central axis to form filter 10. An optional axial space 58 is present along the central axis, which may or may not be connected to interior space 38. During use, fluid is not allowed to flow through axial space 58 in a manner that would allow the fluid to avoid passing through a filter membrane layer 40.

Each membrane layer 40 has a length (in a wound direction, not shown), a width (w), a thickness, a first (front) end 42 (alternately referred to as a “first” end or an “inlet” end) along the wound length, a second (back) end 44 (alternately referred to as a “second” end or an “outlet” end) also along the wound length. Each membrane layer 40 also has two opposed surfaces (46, 48) separated by the thickness of the filter membrane layer, one surface being referred to herein as a front surface 46 (alternately referred to as a “first” surface or an “inlet” surface) and a second surface being referred to as a back surface 48 (alternately referred to as a “second” surface or a “back” surface).

Inlet space 60 is a space that is adjacent to and between two opposed front surfaces 46 of alternating pairs of adjacent filter membrane layers 40 that are part of wound pleat (e.g., “wound outlet pleat”) 54 at their respective second (back) ends 44. Inlet space 60 also includes a portion of interior space 38 within housing 32 that is between inlet 34 and inlet surfaces 46 of membrane layers 40. Optionally, but not illustrated, a spacer layer may be included at inlet space 60 between opposed inlet surfaces 46 of alternating pairs adjacent membrane layers 40.

Outlet space 62 is a space that is adjacent to and between two opposed back surfaces 48 of adjacent filter membrane layers 40 that are part of wound pleat (e.g., “wound inlet pleat”) 52 at their respective first (front, inlet) ends 42. Outlet space 62 also includes a portion of interior space 38 within housing 32 that is between outlet 36 and outlet surfaces 48 of membrane layers 40. Optionally, but not illustrated, a spacer layer may be included at outlet space 62 between opposed outlet surfaces 48 of alternating adjacent membrane layers 40.

Each membrane layer 40 (other than an innermost winding and an outermost winding) forms a wound inlet pleat 52 with an adjacent membrane layer 40 at an end of the filter membrane layer and at one end (inlet end) of the rolled-pleated filter. Inlet ends 42 form rolled inlet pleat 52, which may be a fold between inlet ends 42 of alternating adjacent membrane layers 40, a bonding agent applied to inlet ends 42 of alternating adjacent membrane layers 40, or melted polymer of inlet ends 42 of alternating adjacent membrane layers 40.

Each membrane layer 40 (other than an innermost winding and an outermost winding) forms a wound outlet pleat 54 with an adjacent membrane layer 40 at an end at the opposite end (outlet end) of the rolled-pleated filter. Outlet ends 44 form rolled outlet pleat 54, which may be a fold between outlet ends 44 of alternating adjacent membrane layers 40, a bonding agent applied to outlet ends 44 of alternating adjacent membrane layers 40, or melted polymer of inlet ends 44 of alternating adjacent membrane layers 40.

Each membrane layer 40 (other than an innermost winding and an outermost winding) is connected at edges 42 and 44 to two adjacent membrane layers 40 in an alternating manner. As illustrated, adjacent membranes 40 that have first surfaces 46 that face each other form wound outlet pleat 54 at second (back, outlet) ends 44. Adjacent membranes 40 that have second surfaces 48 that face each other form wound inlet pleat 52 at first (front, inlet) ends 42. This arrangement of pleated first (front, inlet) and second (back, outlet) ends of adjacent filter membrane layers is referred to as an arrangement of alternately-pleated ends of the adjacent filter layer membranes of a wound-pleated filter.

A connected pair of ends of adjacent filter membrane layers can be included as part of a wound pleat that is formed by any technique or structure. The pleat generally is in the form of connected or folded ends of adjacent membrane layers that form a closed end of an inlet or outlet space of the wound-pleated filter, forming pleats at the wound connected ends that cause fluid to flow through the inlet space, through a filter membrane layer, and into the outlet space, and prevent the fluid from by-passing a filter membrane layer.

A pleat between ends of adjacent membrane layers may be formed by or comprise a bonding agent such as a solvent-less thermoplastic bonding agent that is placed between or in contact with front ends or back ends of two adjacent filter membrane layers. The bonding agent is a thermoplastic material that can be reversibly liquefied and solidified by application and removal of heat energy. The bonding agent is preferably one-hundred percent solid thermoplastic polymer with no volatile organic solvent or other chemical component that might evolve in gaseous form from the bonding agent during use of the filter. Example bonding agents include thermoplastic polyolefins, which may be fluorinated or perfluorinated. Specific examples include polypropylene, polyethylene, poly tetrafluoroethylene (PTFE), and polyfluoroalkylenes (PFAs). The bonding agent, of any polymeric composition, may contain a high amount of thermoplastic polymer and a low amount of organic solvent, e.g., at least 95, 99, or 99.9 weight percent thermoplastic solids and less than 5, 1, or 0.1 weight percent organic solvent based on total weight bonding agent.

Preferred polymeric thermoplastics can also have an advantage during automated assembly of a rolled-pleated filter of allowing a small amount of flow of the heated thermoplastic bonding agent after the thermoplastic has been applied to the membrane layers. When winding a pair of membrane layers that have bonding agent that is used to attach adjacent ends of the membrane layers, the membrane layers may be wound at slightly different lengths or may have the same lengths. Each membrane layer can be cross-sealed or otherwise adhered to a core on opposite sides of the core and sealed again on opposite sides of the roll such that the membrane layers are equal in length provided the layers are appropriately sealed and there is no passage of fluid other than through either membrane layer to travel from the inlet to the outlet of the rolled-pleated filter. A preferred thermoplastic bonding agent may be one that can be heated and that can maintain an ability to flow for a short amount of time after being applied to ends of attached membrane layers, because a continued ability of the bonding agent to flow will facilitate a winding process that occurs after application of the bonding agent to a layer, by allowing the bonding agent to flow to accommodate a slightly longer length for an outer layer of a membrane assembly. Membrane layers can be the same width. Each membrane layer can be cross-sealed along the width on opposite sides of the core at the start of the roll and on opposite sides for the end of the roll.

In other examples, a pleat may be in the form of a fold between two adjacent membrane layers. A single piece of porous filter membrane material may be folded along a length to form two adjacent filter membrane layers from the single piece of porous filter membrane material, with the folded pleat connecting the two layers at an end. The folded single piece of membrane material becomes two adjacent layers of a multi-layer porous filter membrane assembly. Each layer has an inlet surface and an outlet surface, and each layer has an inlet end along the length and an outlet end along the length, which are aligned. The adjacent inlet ends (or outlet ends) of adjacent filter membrane layers remain connected and form a folded pleat along the length of the adjacent filter membrane layers.

In still another example, front (inlet) ends or back (outlet) ends of adjacent filter membrane layers may be connected to form a pleat by melted polymer of the adjacent (polymeric) membrane layers. The melted polymer may be formed by any melting technique, for example by laser welding or sonic welding.

Referring again to FIG. 1, in use, fluid can flow into filter assembly 30 through inlet 34, into inlet side space 60. The fluid passes from the inlet, into and through inlet side space 60, and must pass through one of membrane layers 40 (see the arrows) to enter outlet side space 62. From outlet side space 62 the fluid is allowed to exit filter assembly 30 by passing through outlet 36 of housing 32.

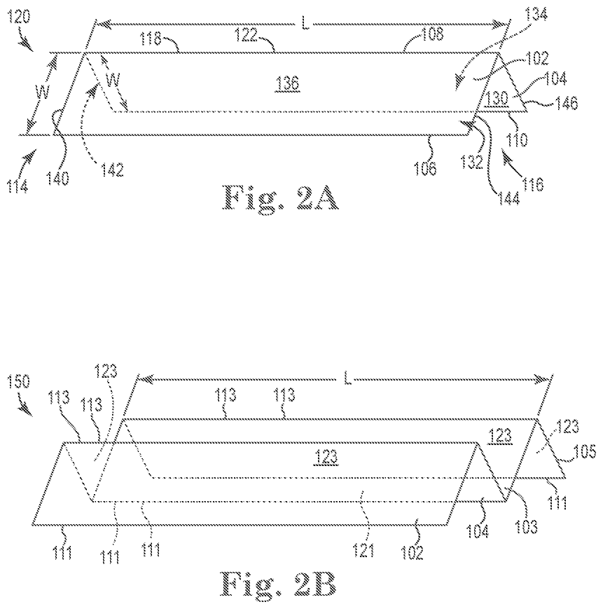

A rolled-pleated filter as described can be prepared by preparing a multi-layer membrane assembly having at least two membrane layers with substantially aligned front and back ends along a length, and a substantially aligned width and length, rolling the assembly along the length of the assembly, and forming a pleat at the front and back ends of alternating membrane layers. A step of forming a pleat at the front and back ends of adjacent, alternating membrane layers may be performed before, during, or after winding the assembly. A useful multi-layer membrane assembly includes at least two filter membrane layers (see FIG. 2A), e.g., a single pair of two filter membrane layers, and may include more than two filter membrane layers (see FIG. 2B).

FIG. 2A shows an example of a multi-layer assembly as described. Multi-layer assembly 120 includes two filter membrane layers having aligned lengths and aligned ends that extend along the length. Filter membrane layer 102 and filter membrane layer 104 each have a length L and a width w. Membrane layer 102 includes a front end 106 that extends along length L, and a back end 118 also extending along length L. Membrane layer 104 includes front end 110 that extends along length L, and back end 122 also extending along length L. Back end 118 of membrane 102 and back end 122 of membrane 104 are connected (e.g., by a fold, as illustrated) at back pleat 108 along the entire length L of membrane layer 102 and membrane layer 104.

Back end 118 of membrane layer 102 and back end 122 of membrane layer 104 can form pleat 108 by any useful method or material. As an example, back end 122 may be connected to back end 118 to form pleat 108 by any one or more of: a bonding agent such as a thermoplastic polymer bonding agent placed in contact with the two layers at their respective back ends; or by melted polymer derived from the two opposed membrane layers at the membrane ends (e.g., formed by laser welding the two polymeric membranes together at their edges); or by a fold that is formed along a length of a double-wide piece of membrane (having a width of 2w) that when folded along a center of the width, along length L, forms assembly 120 with two opposed membrane layers 102 and 104, each having a width w, with folded pleat 108 at ends 118 and 122.

A rolled-pleated filter as described can be prepared by rolling assembly 120 along the length of the assembly and forming pleats at the front (inlet) and back (outlet) ends of alternating membrane layers.

FIG. 2B shows an example of a multi-layer assembly 150 that includes four filter membrane layers having aligned lengths and aligned edges. Filter membrane layers 102, 104, 103, and 105 each have a length L and a width w. Membrane layers include front ends 111 that form a folded pleat with front ends of adjacent filter membranes, and back edges 113 that form a folded pleat with back ends of different adjacent membrane layers. Each membrane has an inlet surface (undersides of membrane layers, as illustrated) 121 that faces an inlet surface 121 of an adjacent membrane layer. Each membrane has an outlet surface (topsides of membrane layers, as illustrated) 123 on the side opposite of the inlet surface. Membranes 103 and 104 have outlet surfaces (topsides of membrane layers, as illustrated) 123 that face one another.

A rolled-pleated filter as described can be prepared by rolling assembly 150 along the length of the assembly, and forming pleats at the front and back edges of alternating membrane layers.

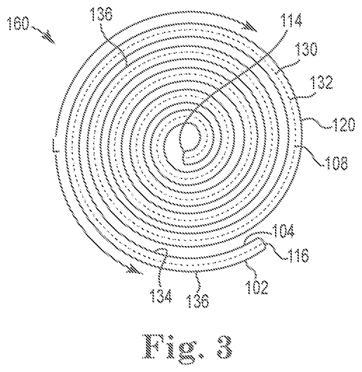

Referring to FIG. 3, illustrated is an end view of rolled-pleated filter 160 formed from multi-layer membrane assembly 120 (alternately assembly 150). Rolled-pleated filter 160 is formed by rolling assembly 120 along length L starting at inner wound end 114 and along the entire length L to outer wound end 116, and by bonding together width-wise edges 140 and 142, and 144 and 146 along the entire width (w). Membrane layers 102 and 104 are aligned with front surface 130 of membrane layer 104 oriented toward (facing) front surface 132 of membrane layer 102 (see the dashed lines of FIG. 3). When wound along length L, assembly 120 forms rolled-pleated assembly 160, with back surface 134 of layer 104 facing back surface 136 of layer 102. Optional spacer layers may be included between surfaces of adjacent membrane layers but are not shown at FIG. 3.

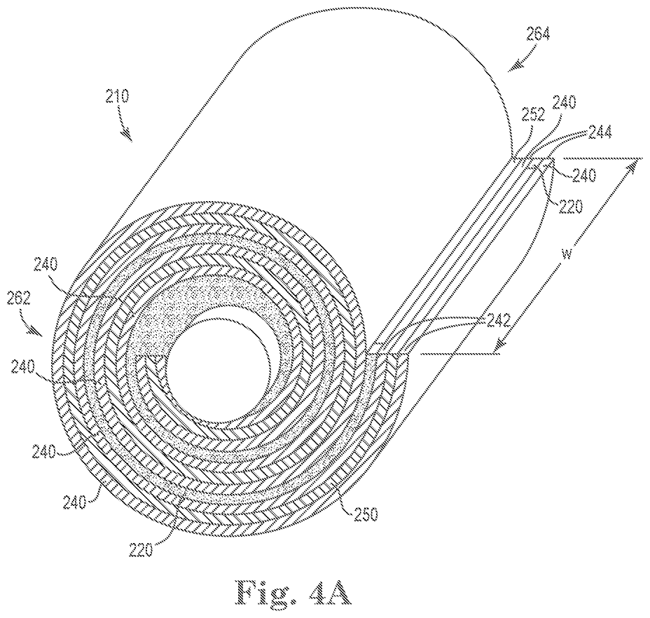

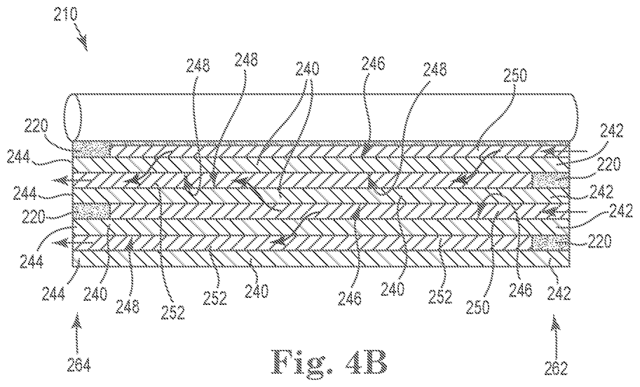

FIGS. 4A and 4B show an end perspective view and a side-cross-section view, respectively, of an example rolled-pleated filter made from a multi-layer assembly that includes two filter membrane layers 240 and two spacer layers 250, 252, with front ends of the membrane layers and back ends of the membrane layers being alternately formed into a pleat using a thermoplastic bonding agent.

Referring to FIGS. 4A and 4B, rolled-pleated filter 210 includes multiple wound-pleated filter membrane layers 240. Each filter membrane layer 240 is separated on adjacent inlet side surfaces of the membrane layers by inlet spacer layer 250, which forms an inlet space between the two adjacent inlet surfaces. Each filter membrane layer 240 is separated on adjacent outlet side surfaces of the membrane layers by an outlet spacer layer 252, which forms an outlet space between the two adjacent outlet surfaces of the membrane layers. Each membrane layer 240 has a length, a width (w), a thickness, a first (front) end 242 (alternately referred to as a “first” end or an “inlet” end) along the length, a second (back) end 244 (alternately referred to as a “second” end or an “outlet” end) also along the length. Each membrane layer 240 also has two opposed surfaces (246, 248 as shown at FIGS. 4B) separated by the thickness of the filter membrane layer, one surface being referred to herein as a front surface 246 (alternately referred to as a “first” surface or an “inlet” surface) and a second surface being referred to as a back surface 248 (alternately referred to as a “second” surface or a “back” surface).

Each membrane layer 240 (other than an innermost winding and an outermost winding) is connected to an adjacent membrane layer 240 at one end (inlet end) of the rolled-pleated filter by thermoplastic bonding agent 220, to form a pleat. Each membrane layer 240 is connected in an alternating manner to a second adjacent membrane layer 240 at a second end (outlet end) of the rolled-pleated filter, to form a second pleat. For example, as illustrated, first (front, inlet) ends 242 of adjacent membranes 240 that are separated by spacer 252 and that have second surfaces 248 that face each other, are connected by thermoplastic bonding agent 220 extending along the wound length L of wound-pleated filter 210 at inlet end 262, to form a wound inlet pleat. Second (back, outlet) ends 244 of adjacent membrane layers 240 that have first surfaces 246 that face each other (separated by spacer 250), are connected by thermoplastic 220 at the opposite end (outlet end 264) of wound-pleated filter 210, to form wound outlet pleat. This arrangement of connected first (front, inlet) and second (back, outlet) edges of adjacent filter membrane layers to form pleats is an arrangement of alternately-connected ends or alternately-pleated ends of adjacent filter layer membranes of wound-pleated filter 210. The starts and ends of the roll must be appropriately sealed as well to eliminate bypass.

A rolled-pleated filter as described may be prepared by any method that is useful to combine filter membrane layers and optional spacer layers in a manner to form a rolled-pleated filter as described. By useful methods generally, a rolled-pleated filter may be prepared from multiple membrane layers and optional spacer layers, including at least two membrane layers, by steps that include, in any useful order: aligning the front and back length-wise ends of the membrane layers, rolling the layers along lengths of the layers to form a wound-rolled filter having multiple windings, and forming pleats between adjacent front and back ends of alternating membrane layers of the windings. A step of forming the pleats between the ends of adjacent, alternating membrane layers may be performed before, during, or after rolling the layers to form the rolled-pleated filter. The width-wise ends at the start and the end of the length, must also be sealed across the entire width, e.g., by a bonding agent, weld (laser weld, sonic weld), or the like. These steps may be performed in a batch-wise method or using an automated system that performs steps of forming a pleat (e.g., by connecting ends or folding a larger membrane into two membrane layers of a multi-layer assembly), aligning layers, and winding layers in a continuous or semi-continuous manner.

As a more specific option, a liquefied (heated, molten) polymeric bonding agent may be applied to ends of two adjacent filter membrane layers to form a pleat, i.e., placed to contact each other and the bonding agent, at a time that is shortly before the two bonded and pleated layers are wound to form a wound rolled-filter. First, an amount of heated, flowable polymeric bonding agent is applied to a location between two membrane layers, at adjacent ends, and the two ends are brought to contact the bonding agent to connect the ends and form a pleat. Soon after applying the bonding agent, the layers are rolled into a winding. Winding occurs soon after applying the liquefied polymeric bonding agent at a time when the bonding agent remains heated, soft, and flowable, so that the layers and the bonding agent are rolled before the bonding agent is cooled and solidified, to allow for slight movement between the layers in a length direction during winding due to differences in wound length of the two membrane layers. The bonding agent has a melting temperature that is less than (below) a melting temperature of the membrane layers and optional spacing layers.

As a different option, a liquefied (heated, molten) polymeric bonding agent may be added to one end of a pair of adjacent membrane layers, in one step, and the bonding agent can be allowed to cool and solidify. Subsequently, the two layers may be wound into a roll, while the bonding agent remains cool and non-flowable. After winding, heat can be applied to the polymeric bonding agent at the wound end to cause the bonding agent to liquefy (melt) at the end, to form a pleat and to seal the adjacent layers together at their ends. This method can be used to seal an inlet end, an outlet end, or both.

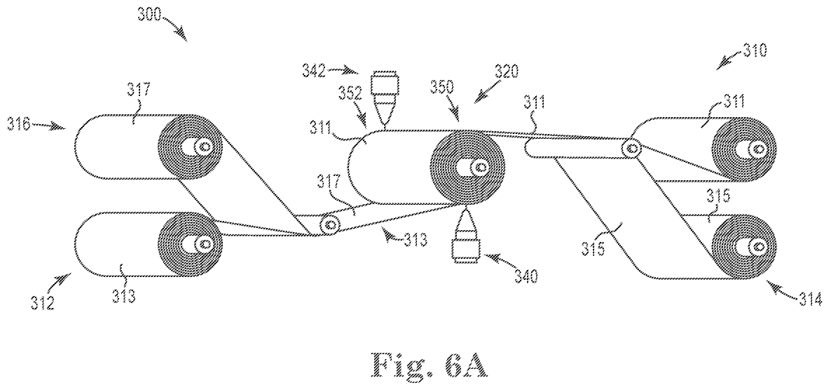

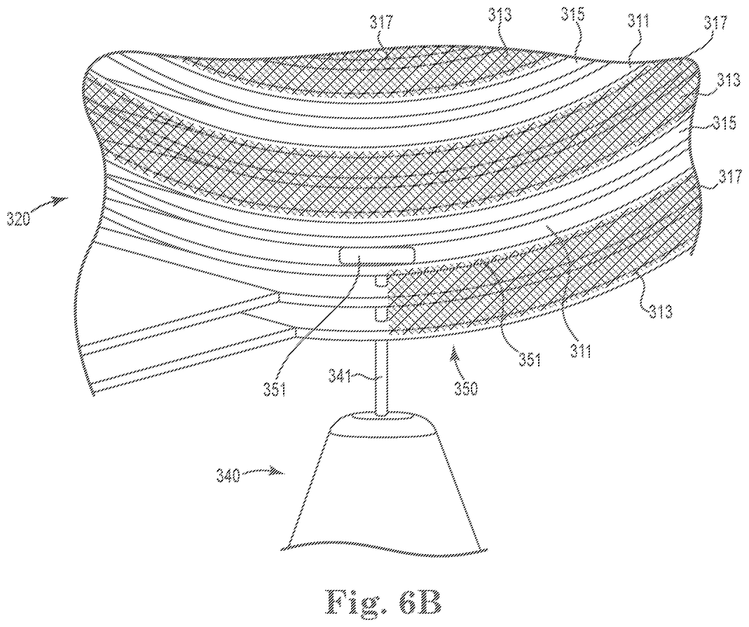

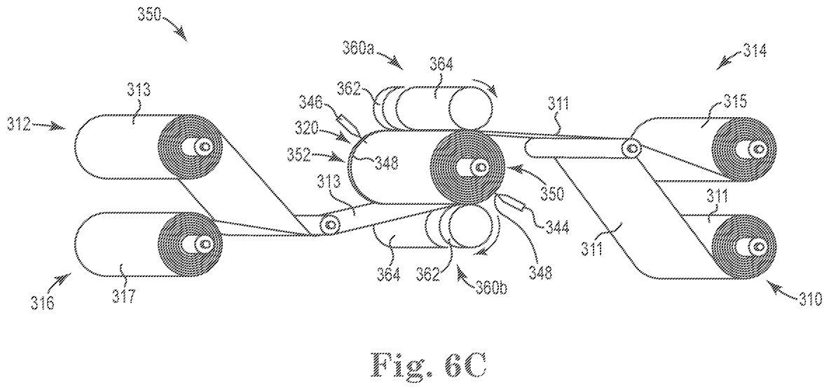

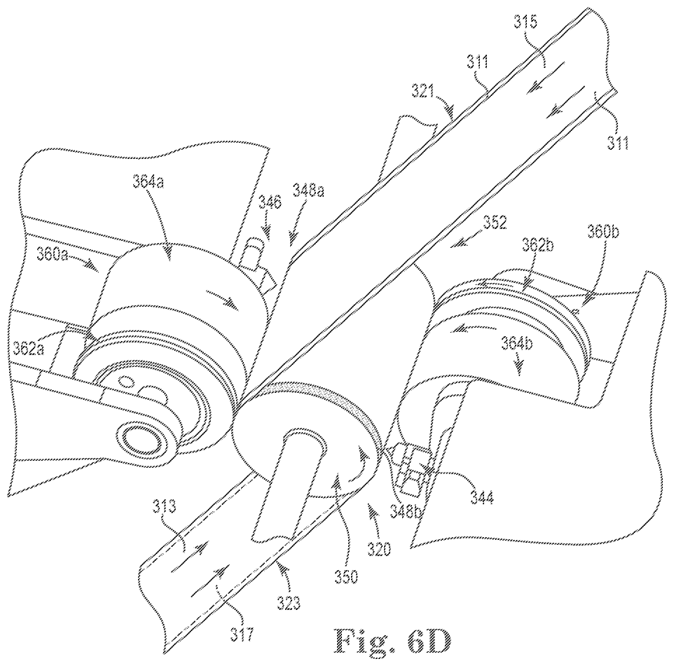

As yet another option, ends of adjacent membrane layers of a wound multi-layer membrane assembly may be connected to form a pleat as the assembly is wound, at outer layers of a winding, using a weld or a bonding agent, at a location at which multiple membrane layers and optional spacer layers are formed into a winding. See, e.g., FIGS. 6A and 6B, below. For example, generally a membrane layer 1, membrane layer 2, a support (spacer layer) layer 1, and support (spacer layer) layer 2 may be fed into a winding by meeting an outer layer of a winding at different locations of the outer surface of the winding. At one location of the winding, membrane layer 1, membrane layer 2, and support 1 are accessible as three exposed layers, at one wound end of the winding, such that a heat source or laser can be applied to connect and seal (forming a pleat) the aligned length-wise ends of the three layers by melting the two membrane layers and the support between the two membrane layers at the first end of the winding. At the opposite end of the winding, membrane layer 1, membrane layer 2, and support 2 are accessible as three exposed layers such that a heat source or laser can be applied to connect and seal (forming a pleat) the aligned length-wise ends of the three layers by melting the two membrane layers and the support between the two membrane layers.

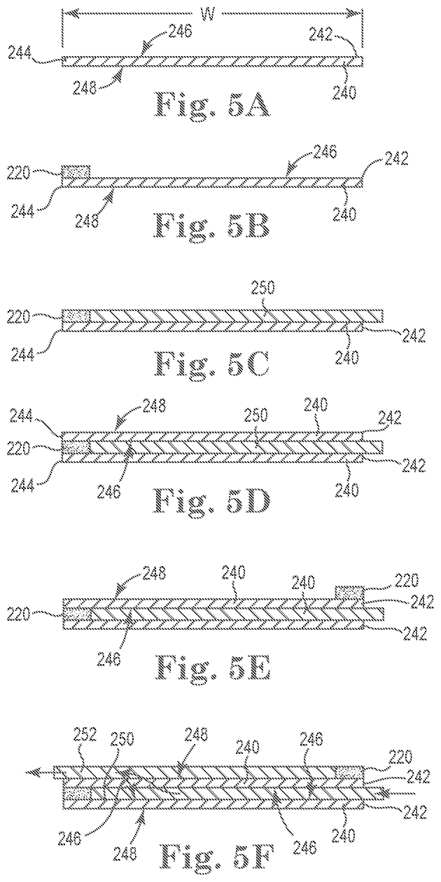

One non-limiting example of a series of useful steps for preparing a rolled-pleated filter is shown at FIGS. 5A through 5F.

In a first step, a filter membrane layer 240 is provided, having front (inlet) length-wise end 242, back (outlet) length-wise end 244, front (inlet) surface 246, and back (outlet) surface 248. Filter membrane layer 240 has a length (not shown), a width (w), and a thickness.

Thermoplastic bonding agent 220 is applied to back end 244 along the length (not shown) of filter membrane layer 240. See FIG. 5B. In alternate embodiments, back ends 244 of adjacent membrane layers 240 may be connected by melted polymer of the layers, which for example may be formed by a laser weld.

Generally, in this or other examples, a bonding agent may be applied to layers of the assembly in any manner that will provide effective formation of a pleat. Bonding agent may be applied to a surface of a support (spacer) layer, may be applied to a membrane layer alongside an end of a support layer (as depicted in FIG. 4A and 4B), or may applied to one or both of the adjacent membrane surfaces or to one or both of the support surface or all of the surface or in any combination thereof or herein. Alternately, membrane layers may be melted together to form a weld at a pleat location.

According to some specific examples, the support layer is present between the bonding edges, and bonding agent is applied between the bonding edges and support layer in a manner to provide adherence through, or in conjunction with, the support layer. In other examples, the bonding agent is placed along the edge of the adjoining support layer or in close proximity to the support layer such that the support layer is contacted by the bonding agent to hold the support layer in position and adhere the support layer to its corresponding membrane layers. In other embodiments, the bonding agent may not be in contact with the support material until after the next membrane layer is applied with pressure and optional heat to cause the bonding agent to extrude and expand across a small portion of the device length such that it contacts and potentially captures the support material. A process of compressing the bonding agent under a next membrane layer also may require applying a bonding agent away from the actual membrane edge to ensure the bonding agent does not protrude from the end of the roll or does not protrude from the end of the roll in an amount that reduces flow performance or adversely affects the assembly process.

Referring again to the figures, a first front spacer layer 250 is placed over front surface 246 of layer 240, between front end 242 and back end 244. See FIG. 5C.

Second filter membrane layer 240, having front end 242, back end 244, front surface 246, and back surface 248, is placed over front spacer layer 250 with front surface 246 of second filter membrane layer 240 contacting a surface of front spacer layer 250. See FIG. 5D.

Thermoplastic bonding agent 220 is applied to front end 242 of second membrane 240, along the length of front end 242. See FIG. 5E.

Second (outlet) spacer layer 252 is placed over back (outlet) surface 248 of second membrane 240. See FIG. 5F.

All of membrane layers 240 and spacer layers 250, 252, are sealed, e.g., by bonding agent, along the width at one end (an inner end) of the length. The assembled layers as shown at FIG. 5F are rolled from the end sealed by the bonding agent (the inner end), along the length, into a cylindrical rolled-pleated filter such as that of FIG. 4A. All of the membrane layers and spacer layers at the exposed end of the length (the outer end) are sealed, e.g., by bonding agent, at the exposed end of the length. The cylindrical rolled-pleated filter is inserted into a cylindrical housing with the wound pleated front ends at an inlet end of the housing and the wound pleated back ends at an outlet end of the housing, with the housing being adapted to cause a flow of fluid to pass through a filter membrane layer 240 when passing from a housing inlet to a housing outlet.

As a different option, FIGS. 6A and 6B illustrate steps of forming a rolled-pleated filter using a continuous or semi-continuous process. As illustrated, system 300 includes membrane 1 source 310, membrane 2 source 312, spacer 1 source 314, and spacer 2 source 316. These sources provide membrane layer 311, membrane layer 313, spacer layer 315, and spacer layer 317, to roll 320.

During forming of roll 320 from membrane layer 311, membrane layer 313, spacer layer 315, and spacer layer 317, laser welds, to form pleats, are formed at alternating ends of each of the two membrane layers using laser welders 340 and 342, one at an inlet end 350 of roll 320 and the other at an outlet end 352 of roll 320, respectively.

In more detail, and with reference to FIG. 6B, membrane layer 311, membrane layer 313, support (spacer layer) layer 315, and support (spacer layer) layer 317, are fed into roll 320, each from a respective source roll 310, 312, 314, and 316. An inlet end of each of membrane layer 311, membrane layer 313, and support layer 317, is accessible as the outer three exposed layers of the winding inlet end 350, at the bottom (as illustrated) of roll 320. Laser 340 applies laser beam 341 to these three layers (see FIG. 6B) to melt, connect, and seal the inlet ends of the three layers and form a pleat at the inlet ends of the three layers. In FIG. 6B, shading across the inlet ends of layers 311, 317, and 313, represents the laser weld that is formed between alternating inlet ends of wound roll 320.

At the opposite end of roll 320, outlet end 352, a comparable arrangement may be used to use laser 342 to form a seal and a pleat at connected ends of outlet ends of layers 311 and 315 with spacer 315 between layers 311 and 315.

Lasers 340 and 342 can be selected to produce a laser beam of a frequency range that is effective to target an appropriate layer or layers on roll 320, to melt the ends of the targeted layers, and generate the necessary seals and form a pleat.

Another example method is shown at FIGS. 6C and 6D. This example uses a bonding agent to form pleats at membrane ends by bonding together alternating ends of each of two membranes, and additionally includes steps and equipment to apply the bonding agent to bonding areas between membranes, evenly with consistent placement and dimensions at the ends of the membranes. As illustrated, system 350 includes membrane 1 source 310, membrane 2 source 312, spacer 1 source 314, and spacer 2 source 316. These sources provide membrane layer 311, membrane layer 313, spacer layer 315, and spacer layer 317, to roll 320.

During forming of roll 320 from membrane layer 311, membrane layer 313, spacer layer 315, and spacer layer 317, bonding material 348 is applied at alternating ends along edge surfaces of each of the two membrane layers 311, 313 using extruders 344 and 346. Bonding agent 348 (e.g., a heated thermoplastic) is applied by extrusion to surfaces of membrane layers 311, 313 along the edges of the membrane layers. At those edges, the spacer layers 315, 317 are not present between the membrane layers, i.e. the edge of the spacer layer 315 is offset from the edge of membrane layer 311 at outlet end 352 to allow for bonding agent 348 to be placed between membrane layers 311 and 313; the edge of the spacer layer 317 is offset from the edge of membrane layer 313 at inlet end 350 to allow for bonding agent 348 to be placed between membrane layer 311 and 313.

The arrangement forms alternately-pleated ends between membranes 311 and 313, one pleated end at an inlet end 350 of roll 320, and one pleated end at an outlet end 352 of roll 320, by using bonding agent 348 to bond together alternating surfaces at edges of membrane 311 and membrane 313. Roller assemblies 360a and 360b contact the outer membrane layer 311, 313 and spacer layers 315, 317 at opposite sides of roll 320 and rotate in a direction opposite of roll 320 during assembly. Each roller assembly 360a, 360b includes a heated roller 362 and a smoothing roller 364. In other embodiments, the heating roller and smoothing roller are one in the same, i.e., continuous along a width

In more detail, and with reference to FIG. 6D, membrane layer 311 and support (spacer layer) layer 315 are fed onto roll 320 prior to moving between roll 320 and roller assembly 360a at one side of roll 320. Membrane layer 313 and support (spacer layer) layer 317, are fed onto roll 320 prior to moving between roll 320 and roller assembly 360b.

To allow bonding agent 348 to be placed to contact two surfaces of membranes 311 and 313, the edge of support layer 315 is spaced laterally from the edge of membrane layer 311 at outlet end 352, forming bonding surface 321 on a top surface (as illustrated) of membrane layer 311, for applying bonding agent 348. Similarly, the edge of support layer 317 is spaced laterally from the edge of membrane layer 313 at inlet end 350, forming bonding surface 323 for applying bonding agent 348 to allow bonding agent to contact the opposite surfaces of both membranes 311 and 313.

As membrane layer 313 (situated above support layer 317 as illustrated) winds around roll 320, membrane layer 313 passes extruder 344 and an amount of bonding agent 348b is applied to bonding surface 323 at the edge of membrane layer 313 at inlet end 350. Support layer 317 and membrane layer 313, with bonding agent 348b applied along bonding surface 323, roll onto roll 320 and on an opposite side of roll 320 are contacted with a bottom (as illustrated) surface of membrane 311, which contacts support layer 317 and bonding agent 348b, forming a pleat between the two membranes 311 and 313 at inlet end 350. As the bottom surface of membrane layer 311 contacts bonding agent 348 applied to bonding surface 323 of membrane 313, roller 362a applies pressure to the membranes and bonding agent 348b, with optional heat, to form a smooth and even layer of bonding material 348b between the two opposed membrane surfaces at inlet end 350. At the same time, smoothing roller 364a contacts an upper (outer) surface of support layer 315 and mechanically adjusts the position of roller 362a and extruder 344 relative to roll 320 as roll 320 increases in diameter.

A similar process is performed at outlet end 352 (not entirely visible at FIG. 6D). As membrane layer 311 (situated below support layer 315 as illustrated) winds around roll 320, membrane layer 311 passes extruder 346 and an amount of bonding agent 348a is applied to bonding surface 321 at the edge of membrane layer 311 at the outlet end. Support layer 315 and membrane layer 311, with bonding agent 348a applied along bonding surface 321, roll onto roll 320 and on an opposite side of roll 320 (not visible) contact a surface of membrane 313, which contacts support layer 315 and bonding agent 348a, forming a pleat between the two membranes at outlet end 352. As the surface of membrane layer 313 contacts bonding agent 348 applied to bonding surface 321 of membrane 311, roller 362 applies pressure to the membranes and bonding agent, with optional heat, to form a smooth and even layer of bonding material 348 between the two opposed membrane surfaces at inlet end 350. At the same time, smoothing roller 364 contacts an upper (outer) surface of support layer 315 and mechanically adjusts the position of roller 362 and extruder 344 relative to roll 320 as roll 320 increases in diameter.

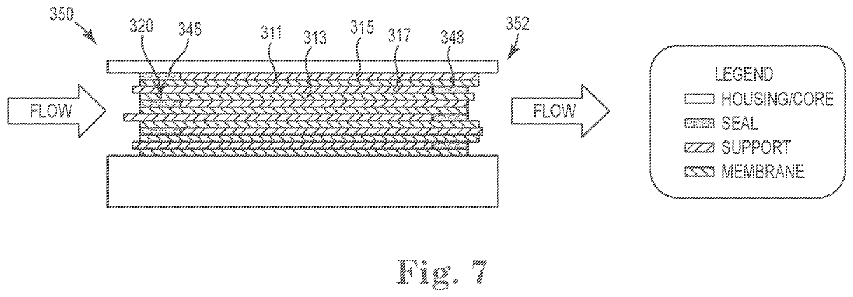

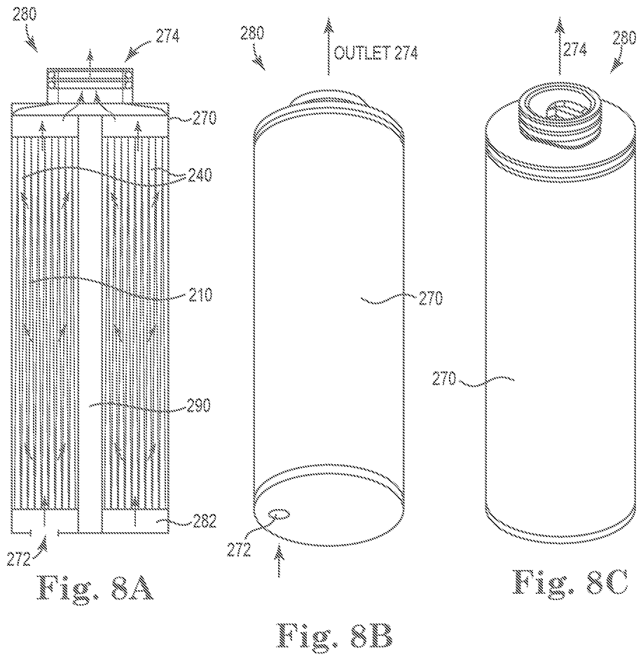

System 350 additionally controls the alignment of edges of membranes 311 and 313 and support layers 315 and 317 as the membranes and support layers are wound onto roll 320. The degree of alignment of the different layers can affect performance of the wound filter differently, particularly with respect to the flow of fluid through the wound filter. See FIG. 7. The alignment of the support layers may be less important to flow properties of the filter. The support layers can range from being slightly proud (extending past the membrane layers) to slightly recessed at either the inlet end or the outlet end without impacting flow of fluid into or from the wound filter. Desirably, an edge of a wound end of a support layer may extend not more than 1 or 3 millimeters past (“proud” relative to) an edge of an adjacent wound membrane layer at an inlet end or at an outlet end. At an outlet end, the membrane layers may be allowed to be slightly proud or slightly recessed because flow of fluid from the outlet end will not cause a proud portion of the membrane at the outlet end to fold over and interfere with flow of fluid from the outlet end. Desirably, an edge of a wound end of a membrane layer at an outlet end may extend not more than 1 or 3 millimeters past (“proud” relative to) an edge of an adjacent wound support layer at an outlet end.

At an inlet end, if membrane is excessively proud of the adjacent support material layers, the membrane may fold over and interfere with fluid flowing into the support layers. See FIG. 7. In a preferred roll, the alignment of membranes 311 and 313 are controlled to produce a high degree of alignment of the edges of membranes 311 and 313 at the inlet end 350. Desirably, an edge of a wound end of a membrane layer at an inlet end may extend not more than 1 millimeters past (“proud” relative to), e.g., not more than 0.5 millimeter past an edge of an inlet end of an adjacent support layer. Alternately or additionally, an edge of a wound end of a membrane layer at an inlet end may extend not more than 1 millimeters past (“proud” relative to), e.g., not more than 0.5 millimeter past an edge of a wound end of a next-adjacent membrane layer, separated from the next-adjacent membrane layer by an inlet end of a support layer or by bonding agent. See FIG. 7. It should be noted that any description of edge sealing throughout this document means sealing may occur at or within close proximity to the edge of the membrane material layers. It is desirable to have the membrane layers adhered as close to their edge as possible to maximize the amount of functional membrane area. It may be desirable to seal away from the edges to accommodate some variability in the process to limit the risk of bonding agent protruding from the membrane layers and potentially restricting fluid flow into the support layers. It is desirable to have the bonding agent at the edge or even slightly proud of the adjacent membrane layers provided it does not protrude enough to cause a restriction of flow into the adjoining support.

FIGS. 7A, 7B, and 7C show an example of a filter assembly that includes a filter housing 270 having inlet 272 and outlet 274 that lead to an interior space that contains rolled-pleated filter 210. As illustrated, filter assembly 280 includes filter 210 within housing 270. Housing 270 includes inlet 272 at one end (a bottom end (as illustrated) or inlet end) of housing 270, and outlet 274 at a second end (a top end (as illustrated) or outlet end) of housing 270. Housing 270 defines interior space 282, which contains filter 210 in a manner that requires fluid that enters inlet 272 to pass through a filter membrane layer 240 of filter 210 before the fluid may pass through outlet 274; i.e., filter assembly 280 is configured as a dead-end type of filter assembly.

Filter 210 is a rolled-pleated filter as described herein. Filter 210 includes multiple wound filter membrane layers 240 formed by rolling a multiple filter membrane layers and optional spacer layers about a central axis that includes axial space 290, which as illustrated forms an open space along the central axis of filter 210, and is separated from the interior space 282 of filter assembly 280 that contains filter 210. Fluid that flows into inlet 272 does not enter axial space 290.

Axial space 290 does not contain a fluid being passed through filter 210, and is advantageously available for use to allow added functionality of filter assembly 280. For example, axial space 290 may contain electronic sensors to monitor conditions or performance of filter 210; for example an electronic temperature or pressure sensor may be inserted into or pass through axial space 290 into interior space 282 to allow direct or indirect monitoring of a condition of filter 210 or a fluid passing through interior space 282. Optionally, axial space 290 may include a solid structure such as a cylindrical (e.g., tubular or solid) roll or bar for additional structure or support of the filter along the central axis. As still a different option, axial space 290 may be small (having a small diameter) or substantially absent, and the center (axial) portion of the rolled-pleated membrane may contain rolled membrane layers that begin at approximately the central axis location.

A rolled-pleated filter as described contains two or more filter membrane layers, each sometimes individually referred to herein as a “filter membrane” or simply “membrane.” Examples of useful filter membranes include membranes made of porous polymer, i.e., porous polymeric filter membranes. A useful porous polymeric membrane has two opposed surfaces (or opposed “sides”) that function as an inlet surface and an outlet surface, with a thickness of the membrane between the two opposed surfaces. The membrane includes a porous structure across the thickness of the membrane that allows for a flow of fluid from one side of the membrane (the inlet side), through the thickness of the membrane, to and through the opposite side (the outlet side) of the membrane. As the fluid passes through the filter membrane, contaminant materials are removed from the fluid by the membrane. Accordingly, the membrane is permeable to a fluid, which may be a liquid or a gas, but retains impurities that are present in the fluid as the fluid passes through the membrane.

The porous membrane contains interconnecting passages (pores, channels, voids) in the form of multiple randomly-directed, tortuous pathways that extend from one surface of the membrane to the opposite surface of the membrane. The passages generally provide tortuous channels or pathways through which a fluid being filtered must pass, and within which an impurity may be removed from the fluid by a sieving or a non-sieving mechanism.

By a “sieving” filtration mechanism, the porous membrane can physically prevent impurities that are present within a fluid from passing through the membrane, i.e., from passing into and through the membrane and exiting the outlet side of the membrane. Impurities (e.g., particles) that are larger than the pores will be prevented from entering the membrane or may be physically prevented from passing through the membrane by the structure of the membrane. Impurities that are smaller than the pores of the membrane may be able to enter the membrane, but may be prevented from passing entirely through the membrane, still by a “sieving” mechanism, by the impurity becoming trapped against a surface or within a space of a tortuous path of the membrane interior. The fluid that is being filtered will pass through the membrane, resulting in flow-through of the fluid that contains a reduced amount of the impurity, which is removed by the filter by the sieving mechanism.

By another filtration mechanism, referred to as a “non-sieving” mechanism, an impurity is not removed by physical separation (sieving), but is attracted to the surface of the filter membrane by an electrostatic or chemical interaction. An impurity such as a dissolved or suspended chemical molecule (e.g., a hydrocarbon, metal, or metal ion), particularly if the molecule includes an electrostatic charge (i.e., is anionic, cationic, etc.), can be chemically (by a chelation mechanism) or electrostatically attracted to a material of the filter membrane, and can be retained by the filter material.

Useful membranes are sometimes referred to as “open pore” membranes, as compared to “closed pore” membranes. The open pore membrane can be in the form of a thin film or sheet of extruded porous polymeric material having a relatively uniform thickness and an open-pore porous structure that includes a polymeric matrix that defines a large number of open “cells,” which are three-dimensional void structures or pores. The open cells can be referred to as openings, pores, channels, or passageways that are largely interconnected between adjacent cells to allow fluid to flow through the thickness of the membrane from one side (the inlet surface) of the membrane to the other side (the outlet surface).

Porous polymeric filter membranes can be constructed of porous polymeric films that have an open pore structure with pores having an average pore size that can be selected based on the expected use of the membrane, i.e., the type of fluid to be filtered or purified using the membrane. Typical pore sizes and average pore sizes for filters used to process highly pure liquids for processing fluids used in semiconductor materials or microprocessing devices are in the micron or sub-micron range, such as from about 0.001 micron to about 10 micron. Example porous polymeric filter membranes may have pores of a size (average pore size) to be considered either a microporous filter membrane or an ultrafilter membrane. A microporous membrane can have an average pore size in a range on from about 0.05 microns to about 10 microns, with the pore size being selected based on one or more factors that include: the particle size or type of impurity to be removed, pressure and pressure drop requirements, flow requirements, and viscosity requirements of a fluid being processed by the filter. An ultrafilter membrane can have an average pore size in a range from 0.001 microns to about 0.05 microns. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

A filter membrane that is useful according to the present description may be made from any of various polymers, including many polymers that are specifically known to be useful for preparing porous polymeric filter membranes. Examples of presently known or preferred polymers include polyamides, polyimides, polyamide-polyimides, polysulfones such as polyethersulfone or polyphenylsulfone, fluoropolymers such as polyvinylidene fluoride, polyolefins such as polyethylene and polypropylene, fluorinated polymers such as perfluoroalkoxy (PFA), and nylons (e.g., nylon 6, nylon 66). The filter membrane may be made from a single type of polymer, or may be made from two or more different polymers, either in a composite or mixture, or as different layers of the membrane.

Suitable polyolefins include, for example, polyethylene (e.g., ultra high molecular weight polyethylene (UPE)), polypropylene, alpha-polyolefins, poly-3-methyl-1-butene, poly-4-methyl-1-butene, and copolymers of ethylene, propylene, 3-methyl-1-butene, or 4-methyl-1-butene with each other or with minor amounts of other olefins; example polyhaloolefins include polytetrafluoroethylene, polyvinylidene fluoride, and co-polymer of these and other fluorinated or non-fluorinated monomers. Example polyesters include polyethylene terephthalate and polybutylene terephthalate, as well as related co-polymers.

A porous polymeric filter membrane may be fluorinated or perfluorinated or may contain entirely non-fluorinated polymer made essentially from non-fluorinated monomers, e.g., may comprise, consist of, or consist essentially of non-fluorinated polymer materials. Example filter layers may comprise, consist of, or consist essentially of polyolefin, such as polyethylene (e.g. UPE). A porous polymeric filter layer that consists essentially of non-fluorinated materials can contain less than 0.5, 0.1, or 0.01 weight percent fluorine. A porous polymeric filter layer that consists essentially of polyolefin, e.g., polyethylene, can be derived from monomers that include at least 99, 99.5, 99.0, or 99.9 weight percent polyolefin (e.g., polyethylene) monomers.

A porous polymeric filter membrane of any composition may optionally be treated, e.g., plasma treated, to enhance adhesion or filtering properties.

Various techniques are known for forming porous filter membranes. Example techniques include melt-extrusion (e.g., melt-casting) techniques and immersion casting (phase inversion) techniques, among others (examples including thermally induced phase inversion (TIPS) and induced phase inversion (NIPS) techniques). Different techniques for forming a porous membrane material can be used to form different porous membrane structures in terms of the size and distribution of pores that are formed within the membrane, i.e., different techniques can be used to produce different pore sizes and membrane structure, sometimes referred to as “morphology,” meaning the uniformity, shape, and distribution of pores within a membrane.

Examples of useful membrane morphologies include homogeneous (isotropic) and asymmetric (anisotropic). A porous membrane that has pores of substantially uniform size uniformly distributed throughout the membrane is often referred to as isotropic, or “homogeneous.” An anisotropic (a.k.a., “asymmetric”) membrane may be considered to have a morphology in which a pore size gradient exists across the membrane; for example, the membrane may have a porous structure with relatively larger pores at one membrane surface, and relatively smaller pores at the other membrane surface with the pore structure varying along the thickness of the membrane. The term “asymmetric” is often used interchangeably with the term “anisotropic.” Often, a portion of a membrane that has relatively smaller pores (compared to other regions of the membrane) is referred to as a “tight” region, and a portion of a membrane that has larger pores is often called an “open” region. In a rolled-pleated filter as described, an anisotroptic membrane may be used with the tight region toward an inlet space and an open region toward an outlet space, or with the open region toward the inlet space and the tight region toward the outlet space.

A filter membrane can also be characterized by bubble point, which can be measured by various techniques. According to an example bubble point test methods, a sample porous polymeric filter membrane is immersed in and wetted with a liquid having a known surface tension, and a gas is applied at a known pressure to one side of the sample. The gas pressure is gradually increased. The minimum pressure at which the gas flows through the sample is called a bubble point. Examples bubble points of a porous polymeric filter membrane that is useful or preferred according to the present description, measured using HFE 7200, at a temperature of 20-25 degrees Celsius, can be in a range from 1 to 400 pounds per square inch (psi), such as from 2 to 300 psi, e.g., in a range from 10 to 200 psi.

A porous filter membrane can also be characterized by porosity. A porous polymer filter layer as described may have any porosity that will allow the porous polymer filter layer to be effective as described herein, for filtering a flow of liquid to produce a high purity filtered liquid material. Example porous polymer filter layers can have a relatively high porosity, for example a porosity of at least 30 percent, or at least 50 percent, e.g., a porosity in a range from 30 to 85 percent. As used herein, and in the art of porous bodies, a “porosity” of a porous body (also sometimes referred to as void fraction) is a measure of the void (i.e. “empty”) space in the body as a percent of the total volume of the body, and is calculated as a fraction of the volume of voids of the body over the total volume of the body. A body that has zero percent porosity is completely solid.

A porous polymeric filter membrane as described can be in the form of a sheet (thin film) having any useful thickness, e.g., a thickness in a range from 2 to 200 microns, e.g., from 10 to 100 microns. Optionally, a thickness of a filter membrane layer may vary or taper along the width of the membrane, between an inlet end and an outlet end of the membrane. For example, a filter membrane may have a greater thickness at an inlet end and a reduced thickness at an outlet end.

A filter as described can optionally and preferably contain two spacer layers. One spacer layer may be present at the input space between opposed input surfaces of adjacent membrane layers, and one spacer layer may be present at the output space between opposed output surfaces of adjacent membrane layers.

A spacer layer has two opposed surfaces (or opposed “sides”) separated by a thickness, and also has a length and a width. A spacer layer functions to create space (inlet space or outlet space) between adjacent inlet surfaces or adjacent outlet surfaces of filter membrane layers of the rolled-pleated filter. The spacer layer is designed to create the space while allowing fluid to flow through the space, by introducing a low amount of resistance to flow of fluid through space created by the spacer layer. The spacer layer is not required to act as a filter membrane, to remove impurities or contaminants from a fluid that passes through the spacer layer.

A spacer layer can be filter membranes can be constructed of an open structure, which may be polymeric (e.g., an extruded porous polymeric membrane), a fabric material that is woven or non-woven, a punched-film, corrugated, etc., having a highly open structure to allow good flow of fluid through the spacer layer. A spacer layer as described may have any porosity that will allow flow of fluid through the volume of the spacer layer, with a low resistance to the flow. Example spacer layers can have a very high porosity, while having physical properties that maintain a separation between adjacent surfaces of filter membrane layers during use of the filter. Examples of useful porosities may be greater than 65, 70, 80 or percent, e.g., in a range from 65 to 98 percent.

A spacer layer described can be in the form of a sheet (thin film) having any useful thickness, e.g., a thickness in a range from 10 to 2000 microns, e.g., from 50 to 500 microns. Optionally, a thickness of a spacer layer may vary or taper along the width of the membrane, between an inlet end and an outlet end of the membrane. For example, a filter membrane may have a greater thickness at an inlet end and a reduced thickness at an outlet end.

A rolled-pleated filter of the present description can be useful for processing fluids that are among broad range of liquid or gaseous fluids of commercial importance. These include liquids in any industry, but particularly include fluids that are used as process solvents, cleaning agents, and other processing solutions for semiconductor and microelectronic device processing that are used at very high levels of purity. Examples of these types of fluids include liquid materials (e.g., solvents) used in photolithography, cleaning or other various processes of microelectronic devices preparation. Specific examples include process solutions for spin-on-glass (SOG) techniques, for backside anti-reflective coating (BARC) methods, for photolithography, for cleaning, for a purging step, and for a deposition step (e.g., chemical vapor deposition (including plasma-enhanced chemical vapor deposition and other variations), atomic layer deposition, and the like.

An impurity is a chemical material that is different from the process fluid, that is dissolved in a liquid process fluid or suspended in a gaseous process fluid. Examples, described chemically, include hydrocarbon molecules including charged (ionic) molecules and oligomers, inorganic compounds such as metal oxides (titanium dioxide), metal atoms, metal ions, etc. In a fluid that is in gaseous form, a contaminant may be any material known as an “airborne molecular contaminant” (AMC), which is a chemical material in the form of a vapor or aerosol that has a detrimental effect on a product or a process, if present. These chemicals may be organic or inorganic in nature and includes acids, bases, polymer additives, organometallic compounds, and dopants. A source of airborne molecular contamination is building and cleanroom construction materials, general environment, process chemicals, and operating personnel.

Some specific, non-limiting examples of liquid organic solvents that can be filtered using a wound-pleated filter as described, to remove a trace impurity, include: alkanes (methane, butane, hexane, and other C3 through C10 alkanes), n-butyl acetate (nBA), isopropyl alcohol (IPA), 2-ethoxyethyl acetate (2EEA), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

Certain types of impurities may be present in certain types of liquid process fluids. For example, polar organic solvents such as isopropyl alcohol may contain trace amounts of a hydrocarbon, a metal oxide, or a metal ion. Example methods as described can include removing one or more of these impurities from a polar organic solvent such as isopropyl alcohol.

Non-polar organic solvents such as alkanes (e.g., hexane) may typically include impurities such as a hydrocarbon analog (e.g., a different non-polar alkane such as methane, propane, butane, or a C5 through C10 alkane), a hydrocarbon oligomer derivative of the alkane impurity or the non-polar organic solvent, or a metal. Example methods as described can include removing one or more of these impurities from a non-polar organic solvent such as hexane.

1. A wound-pleated filter useful to reduce an amount of a trace impurity in a fluid, the wound-pleated filter comprising:
a multi-layer filter membrane assembly comprising a first porous filter membrane layer and a second porous filter membrane layer, each of the first porous filter membrane layer and the second porous filter membrane layer comprising an inlet surface, an outlet surface, a length, an inlet end that extends along the length, an outlet end that extends along the length, and a width between the inlet end and the outlet end, with:
the porous filter membrane layer assembly wound along the length, about a central axis, to form the wound-pleated filter, with:
the inlet surface of the first porous filter membrane layer facing an inlet surface of the second porous filter membrane layer,
a wound inlet pleat that comprises inlet ends of adjacent filter membrane layers at an inlet end of the wound-pleated filter, and
a wound outlet pleat that comprises outlet ends of adjacent filter membrane layers at an outlet end of the wound-pleated filter.

2. The filter of claim 1 comprising multiple porous filter membrane layer windings.

3. The filter of claim 1 comprising an outlet surface of the first porous filter membrane layer facing an outlet surface of an adjacent porous filter membrane layer.

4. The filter of claim 1, the wound inlet pleat comprising:
a fold between the inlet ends of adjacent porous filter membrane layers,
inlet ends of two adjacent porous filter membrane layers bonded together by bonding agent, or
inlet ends of two adjacent porous filter membrane layers bonded together by a weld.

5. The filter of claim 1, the wound outlet pleat comprising:
a fold between the outlet ends of adjacent porous filter membrane layers,
outlet ends of two adjacent porous filter membrane layers bonded together by bonding agent, or
outlet ends of two adjacent porous filter membrane layers bonded together by a weld.

6. The filter of claim 4, the bonding agent comprising thermoplastic polymer selected from: a polyolefin, a fluoropolymer, and a perfluoropolymer.

7. The filter of claim 4, the bonding agent selected from:
polypropylene, polyethylene, poly tetrafluoroethylene (PTFE), and a polyfluoroalkylenes (PFA).

8. (canceled)

9. The filter of claim 1 wherein each of the first membrane layer and the second membrane layer comprises polymeric membrane capable of reducing an amount of a trace impurity from a fluid as the fluid passes through the polymeric membrane.

10. The filter of claim 1 wherein each of the first porous filter membrane layer and the second porous filter membrane layer comprises polymer selected from: a polyamide, a polyimide, a polyamide-polyimide, a polysulfone, a fluoropolymer, and a nylon.

11. The filter of claim 1, wherein each of the first porous filter membrane layer and the second porous filter membrane has a thickness in a range from 2 to 200 microns.

12. The filter of claim 1, wherein each of the first porous filter membrane layer and the second porous filter membrane comprises a polymeric membrane having a symmetrical morphology.

13. The filter of claim 1, wherein each of the first porous filter membrane layer and the second porous filter membrane comprises a polymeric membrane having an asymmetrical morphology.

14. The filter of any of claim 1, having a total inlet surface area in a range of 0.1 to 100 square meters.

15. (canceled)

16. The filter of claim 1 comprising:
an inlet-side spacer between the inlet surface of the first porous filter membrane layer and the inlet surface of the second porous filter membrane layer, and
an outlet-side spacer located between an outlet surface of the porous filter membrane layer and an outlet surface of an adjacent porous filter layer membrane.

17. The filter of claim 16, wherein each of the inlet-side spacer and the outlet-side spacer has a thickness in a range from 10 to 2000 microns.

18. (canceled)

19. (canceled)

20. A wound-pleated filter comprising:
a multi-layer filter membrane assembly comprising a first porous filter membrane layer and a second porous filter membrane layer, each of the first porous filter membrane layer and the second porous filter membrane layer comprising an inlet surface, an outlet surface, a length, an inlet end that extends along the length, an outlet end that extends along the length, and a width between the inlet end and the outlet end, with:
the porous filter membrane layer assembly wound along the length and about a central axis to form the wound-pleated filter comprising multiple porous filter membrane layer assembly windings, with:
the inlet surface of the first porous filter membrane layer facing an inlet surface of the second porous filter membrane layer,
a pleat comprising an outlet end of the first porous filter membrane layer and an outlet end of an adjacent porous filter membrane layer, the pleat comprising a fold, a weld, or a thermoplastic bonding agent, and
wound inlet ends of the membrane layers at an inlet end of the wound-pleated filter,
wound outlet ends of the membrane layers at an outlet end of the wound-pleated filter.

21. The filter of claim 20, comprising:
an outlet surface of a first porous filter membrane layer facing an outlet surface a second porous filter membrane layer of an adjacent filter membrane layer,
a pleat comprising an inlet end of the first porous filter membrane layer and an inlet end of an adjacent filter membrane layer, the pleat comprising a fold, a weld, or a thermoplastic bonding agent.

22. The filter of claim 20, wherein each of the first porous filter membrane layer and the second porous filter membrane layer has a thickness in a range from 2 to 200 microns.

23. The filter of claim 20, wherein each of the first porous filter membrane layer and the second porous filter membrane layer comprises polymer selected from: a polyamide, a polyimide, a polyamide-polyimide, a polysulfone, a fluoropolymer, and a nylon.

24-28. (canceled)

29. A method of removing an impurity from a fluid, the method comprising:
causing fluid to pass through a filter of claim 1, the fluid comprising a trace impurity, such that the filter membrane retains a portion of the trace impurity.

30-55. (canceled)
